(19) United States
(12) Patent Application Publication
(10) Pub. No.: US 2011/0244296 A1
(43) Pub. Date: Oct. 6, 2011

(54) BATTERY MODULE

(75) Inventors: Hiroyuki Okuda, Kobe-shi (JP); Yoshito Kaga, Kobe-shi (JP); Atsuhiro Funahashi, Osaka (JP)

(73) Assignee: SANYO ELECTRIC CO., LTD., Osaka (JP)

(21) Appl. No.: 13/074,662

(22) Filed: Mar. 29, 2011

(30) Foreign Application Priority Data
Mar. 30, 2010 (JP) 2010-078642

(51) Int. Cl. H01M 10/50

(52) U.S. Cl. 429/120

(57) ABSTRACT

A battery module (10) has heat absorbers (41) each disposed in an internal space of each of connection portions of the positive and negative electrode terminals (11, 12) so as to be in contact with the connection portion, and wherein at least one of the heat absorbers (41) located closer to a central portion of a multi-cell assembly with respect to the cell stacking direction has a greater volume than at least one of the heat absorbers (41) located closer to a periphery of the multi-cell assembly, and a radiation sheet (42) disposed on a side face of the multi-cell assembly (1P), wherein the radiation sheet (42) covers a current collector-side edge in a side face of the multi-cell assembly (1P) substantially entirely from one end to another end, and the radiation sheet (42) has a tapered shape such as to gradually converge from the current collector-side edge to the opposite side edge toward a central portion of the multi-cell assembly (1P) with respect to a cell stacking direction.

### BACKGROUND OF THE INVENTION

1. Field of the Invention

The present invention relates to a battery module in which a plurality of cells are connected to one another, and more particularly to a battery module having a heat dissipation function that can achieve uniformization of the temperature distribution between the cells and within a cell in a compact manner.

2. Description of Related Art

Power sources for robots, electric vehicles, and mobile devices with low power, for example, need to be small, lightweight, and low cost because they are accommodated in a limited amount of space. Lithium-ion batteries, which offer high energy density, have attracted attention as they meet such requirements. The lithium-ion batteries are used to form a battery module in which a multiplicity of cells, for example, about 5 or 6 cells through over 10 cells, are stacked and connected in series or in parallel to one another, in order to obtain high power.

The battery module used for such applications as described above is used at high rate, and each of the cells generates during charge and discharge. However, when the battery module is placed in a limited amount of space as described above, the heat cannot be dissipated in the air, so the battery temperature can easily rise. Consequently, a problem arises that the battery cannot be discharged when the battery temperature reaches the operating temperature upper limit. Since the battery is arranged in a limited amount of space, it is difficult to provide a forced air-cooling mechanism such as a fan therein, so it is necessary to release the heat by heat conduction to an external solid matter or heat radiation.

Generally, in a battery module, a cell located closer to the central portion with respect to the stacking direction (arrangement direction) of the plurality of the cells has a more limited heat dissipation area than a cell located closer to the periphery, and therefore tends to be heated more easily. The consequent problems are that, for example, variations occur in the voltages obtained from the cells, and that only the cell or the cells in the central portion may deteriorate earlier because of the temperature increase.

In view of the problem, Japanese Published Unexamined Patent Application No. 2010-10460 (Patent Document 1) discloses an electric storage device (battery module) in which heat dissipating members provided between cells and the heat dissipation members are connected with each other at their side surfaces to exchange the heat from the cells with each other and to average out the temperatures among the cells so that variations in the charge-discharge characteristics between the cells can be lessened.

In a battery module, especially when the battery module is charged and discharged at high current, a great deal of current passes through the terminals of each cell and the adjacent portions, and the temperature tends to rise easily in those portions. Consequently, the terminals and the adjacent portions are most likely to be affected by the battery deterioration or the like. Additional problem is that, when each of the cells is constructed using a laminate battery case, it is difficult to firmly seal the laminate at the portions from which the terminals protrude, so the portions may peel because of the temperature increase, making it difficult to maintain durability.

In the battery module disclosed in the above-mentioned Patent Document 1, however, the heat dissipation members disposed between the cells are merely connected with each other at the side surfaces, and the temperature increase in the terminal portions are not particularly prevented.

In the battery module disclosed in Patent Document 1, the heat from the cells is exchanged with each other in the side surfaces, so the temperatures between the cells can be averaged to a certain degree. However, since the heat dissipation members are provided uniformly for the respective cells, the problem with the structure, in which the cell located closer to the central portion with respect to the stacking direction (arrangement direction) of the plurality of cells is inferior in the heat dissipation performance to the cell located closer to the periphery, is not sufficiently resolved. Thus, the battery module disclosed in Patent Document 1 does not sufficiently inhibit the variations in the charge-discharge characteristics between the cells.

Another problem with the battery module disclosed in Patent Document 1 is that, since the heat dissipation members are provided between the cells, the space required for the heat dissipation members increases the volume of the battery, correspondingly decreasing the volumetric energy density of the battery.

### BRIEF SUMMARY OF THE INVENTION

It is an object of the present invention to provide a battery module that can inhibit temperature increase in the terminals and the adjacent portions effectively without, in effect, decreasing the volumetric energy density of the battery and at the same time can make the temperature distribution between the cells uniform effectively.

In order to accomplish the foregoing and other objects, the present invention provides a battery module, comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell; and

heat absorbers each disposed in an internal space of each of connection portions of the positive and negative electrode terminals so as to be in contact with the connection portion,

wherein at least one of the heat absorbers located closer to a central portion of the multi-cell assembly with respect to the cell stacking direction has a greater volume than at least one of the heat absorbers located closer to a periphery of the multi-cell assembly.

The present invention also provides a battery module, comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell; and

a heat absorber disposed in a surrounding space around each of connection portions of the positive and negative electrode terminals so as to be in contact with the connection portion,

wherein the heat absorber has a greater volume in a central portion thereof with respect to the cell stacking direction than in a periphery thereof.

The battery module according to the present invention makes it possible to inhibit temperature increase in the terminals and the adjacent portions effectively without, in effect, decreasing the volumetric energy density of the battery and at the same time to make the temperature distribution between the cells uniform effectively.

### BRIEF DESCRIPTION OF THE DRAWINGS

FIG. 1 is a perspective view illustrating a stack type battery that constitutes a battery module of the present invention;

FIG. 2 is a perspective view illustrating the battery module of the present invention;

FIG. 3 is a side view illustrating the battery module of the present invention;

FIG. 4 is a plan view illustrating a heat absorbing heat that constitutes the battery module of the present invention;

FIG. 5 is a schematic side view illustrating another example of a multi-cell assembly; and

FIG. 6 is a schematic partial side view illustrating another example of the heat absorber.

### DETAILED DESCRIPTION OF THE INVENTION

In one aspect, the present invention provides a battery module, comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell;

heat absorbers each disposed in an internal space of each of connection portions of the positive and negative electrode terminals so as to be in contact with the connection portion,

wherein at least one of the heat absorbers located closer to a central portion of the multi-cell assembly with respect to the cell stacking direction has a greater volume than at least one of the heat absorbers located closer to a periphery of the multi-cell assembly; and

a radiation sheet disposed on a side face of the multi-cell assembly,

wherein the radiation sheet covers a current collector-side edge in a side face of the multi-cell assembly substantially entirely from one end to another end, and the radiation sheet has a tapered shape such as to gradually converge from the current collector-side edge to the opposite side edge toward a central portion of the multi-cell assembly with respect to a cell stacking direction.

In the present invention, the term “the connection portions of the positive and negative electrode terminals” means at least a portion of the part including the positive electrode terminal itself and the negative electrode terminal itself of each cell and another conductor for joining the positive electrode terminals or the negative electrode terminals when positive electrode terminals or the negative electrode terminals are connected via the conductor, in other words, at least a portion of the entire part of not only the joint portion in which the positive electrode terminals or the negative electrode terminals are connected to one another directly or indirectly via another conductor but also the portion other than the joint portion including the positive electrode terminal itself or the negative electrode terminal itself.

The term “an internal space of the connection portion of the positive and negative electrode terminals” means to include, for example, the inner space formed inside the positive and negative electrode terminals when the positive and negative electrode terminals is connected at their foremost end portions.

The term “a side face of the multi-cell assembly” means a side face thereof that extends along the cell stacking direction (arrangement direction) and is adjacent to a face in which the connection portions of the positive and negative electrode terminals exist.

The term “the current collector-side edge in a side face of the multi-cell assembly” means, of the four side edges in a side face of the multi-cell assembly, the side edge adjacent to the face of the multi-cell assembly in which the connection portions of the positive and negative electrode terminals exist.

In the present invention, the terms “the central portion” and “the periphery” with respect to the cell stacking direction (arrangement direction) basically mean, respectively, the portion closer to, and the portion farther from, the midpoint in the total thickness T (1/2 T point) when the cells are stacked. For example, it is possible to define the number of cells defined as follows as the cell(s) closer to the central portion.

The number of the central cells is an odd number when the total number of the cells is an odd number equal to or greater than 3, whereas the number of the central cells is an even number when the total number of the cells is an even number equal to or greater than 4. The number of the central cells can be defined by the following equations.

The number of the central cells=INT(n×0.25/2)×2+1, when the total number of the cells n is an odd number (where n≧3).
The number of the central cells=INT((n−4)×0.25/2)×2+2, when the total number of the cells n is an even number (where n≧4).
In the equations, 0.25 represents the proportion of the central cells/the total number of the cells, which may be from 0.20 to 0.30. In the equations, INT(x) represents INT function for truncating the fractional portion of x and rounding it to an integer.

In the above-described configuration of the present invention, each of the heat absorbers is disposed in an internal space of each of the connection portions of the positive and negative electrode terminals so as to be in contact with the connection portion, and the radiation sheet has such a shape as to cover at least a current collector-side edge in a side face of the multi-cell assembly substantially entirely from one end to another end. As a result, the temperature increase in the connection portions of the positive and negative electrode terminals and the adjacent portions thereto can be inhibited effectively. In other words, the heat absorbers and the radiation sheet are disposed intensively in the connection portions of the positive and negative electrode terminals and the adjacent portions thereto, so that the temperature increase can be inhibited effectively. The connection portions of the positive and negative electrode terminals and the adjacent portions thereto are the locations in which the temperature tends to rise especially easily. So, if no heat dissipation means is provided, the heat from these locations can flow into the cells and cause damages to the cells. However, when the heat absorbers and the radiation sheet are disposed intensively in the connection portions of the positive and negative electrode terminals and the adjacent portions thereto as in the above-described configuration of the present invention, the heat generated at these locations is stored (absorbed) by the heat absorbers and the radiation sheet, and thereafter transmitted and dissipated to the air by radiation. Thus, the heat flow into the cells is lessened.

In addition, at least one of the heat absorbers located closer to the central portion of the multi-cell assembly with respect to the cell stacking direction has a greater volume than at least one of the heat absorbers located closer to the periphery of the multi-cell assembly, and the radiation sheet has a tapered shape such as to gradually converge from the current collector-side edge to the opposite side edge toward the central portion of the multi-cell assembly with respect to the cell stacking direction. Thereby, the effect of inhibiting the temperature increase by the heat absorbers and the radiation sheet is exhibited noticeably in the central region in which the temperature can rise more easily, so that the temperature distribution between the cells can be made uniform effectively. Moreover, since the volume of the heat absorbers and that of the radiation sheet are smaller in the periphery region, the required amount of the heat absorbers and that of the radiation sheet can be saved correspondingly.

Moreover, since each of the heat absorbers is disposed in the internal space of each of the connection portions of the positive and negative electrode terminals, the occupied space by the heat absorbers does not increase the volume of the battery. In other words, the internal space of each of the connection portions of the positive and negative electrode terminals, which would otherwise have been dead space, is utilized efficiently to dispose the heat absorber therein to thereby achieve the structure in which the total volume of the battery is not increased by the occupied space by the heat absorbers. Other than the heat absorbers, only the radiation sheet is provided on the side face of the multi-cell assembly, and no other component for inhibiting temperature increase is additionally provided in the battery module, for example, in the space between the cells. Thus, the battery volume is not increased in effect by other components than the heat absorbers. That is, in the above-described configuration of the invention, the heat absorber and the radiation sheet, which are the means for inhibiting temperature increase, can effectively inhibit the temperature increase in the connection portions of the positive and negative electrode terminals and the adjacent portions thereto without, in effect, increasing the battery volume, and at the same time make the temperature distribution between the cells uniform effectively.

Suitable examples of the heat absorber include one made of resins such as silicone resin, acrylic resin, and epoxy resin and one made of rubber. Silicone rubber (polymer) has the skeleton represented by the following chemical formula (1). It contains a heat conductive filler and shows a high heat dissipation effect (thermal conductivity: 1-5 W/m·K). It is also excellent in electrical insulation capability, elasticity, adhering capability with the electrode terminals, strength, and flame-retardant capability, and is usable in a wide temperature range (from about −30° C. to about 200° C.).

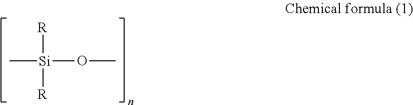

(R is H or an Alkyl Group.)

Suitable examples of the heat conductive filler include metal oxides (such as alumina Al₂O₃, and ZnO), nitrides (such as aluminum nitride MN), metals (such as Cu and Al), and carbon compounds (such as SiC). More suitable are metal oxides and nitrides that are electrically insulative. Table 1 below shows the thermal conductivities and specific gravities of the heat conductive fillers.

TABLE 1

| | AlN | SiC | Al₂O₃ | ZnO | Cu | Al |
|---|---|---|---|---|---|---|
| Thermal conductivity | 300 | 60 | 36 | 25 | 398 | 237 |
| [W/m · K] | | | | | | |
| Specific gravity | 3.3 | 3.2 | 4.0 | 5.5 | 9.0 | 2.7 |

Acrylic rubber uses an acrylic-based rubber as the base polymer. Since it is non-silicone rubber, it has the features of not containing halogen or a low-molecular-weight siloxane, for example, in contrast to the silicone rubber. Moreover, it is excellent in heat resistance. In addition, it has excellent thermal conductivity, and the thermal conductivity can be improved further by containing the same kind of heat conductive filler as contained in the silicone rubber. The thermal conductivity of the acrylic rubber is dependent on the type and the amount of the heat conductive filler contained. An example of acrylic rubber sheet is “EFCO™ Sheet” (trademark of Furukawa Electric Co., Ltd.), which is an acrylic rubber sheet having a thermal conductivity of 1.6-3.0 W/m·K and using magnesium oxide (thermal conductivity: 60 W/m·K) as the filler.

An epoxy film sheet uses an epoxy resin as the base material and contains the same kind of heat conductive filler as contained in the silicone rubber. An example of the epoxy film sheet is “Hiset” (trademark of Hitachi Chemical Company, Ltd.), which is an epoxy film sheet having a thermal conductivity of 5-10 W/m·K and using an organic material as the filler.

Suitable examples of the radiation sheet include an electrically insulative sheet using glass fabric as the core material and containing a heat conductive filler affixed thereon by a resin to improve the radiation capability, and a sheet using a metal such as aluminum and copper as the core material and coating a resin such as a polyimide resin thereon.

The just-described sheet using glass fabric as the core material has a high radiation effect (emissivity (thermal emissivity): 0.9 or higher). It is excellent in flexibility, adhering capability with a side face of the battery, strength, and flame-retardant capability, and is usable in a wide temperature range (from about −30° C. to about 100° C.).

As the heat conductive filler, the same type of heat conductive filler as contained in the silicone rubber of the heat absorber may be used. Alternatively, Cerac a (trademark of Oki Electric Industry Co., Ltd.) may be coated on the core material in place of the heat conductive filler, to prepare a sheet material. “Cerac a” is a liquid ceramic paint developed jointly by Oki Electric Industry Co., Ltd. and Ceramission Corp., which dissipates heat by converting heat into infrared rays.

It is desirable that a heat absorbing sheet be disposed between a side face of the multi-cell assembly and the radiation sheet.

With this configuration, heat is absorbed and stored in the heat absorbing sheet from the side face of the multi-cell assembly, and moreover, the heat is dissipated by the radiation effect of the radiation sheet. Therefore, the temperature increase can be inhibited more effectively.

In the above-described configuration, the heat absorbing sheet may have the same shape as that of the radiation sheet, or may have a shape such as to cover the entire side face of the multi-cell assembly (for example, a rectangular shape) so that the heat storing capability (thermal capacity) can be as high as possible. However, even when the heat absorbing sheet has a shape such as to entirely cover the side face of the multi-cell assembly in this way, it is necessary that, as described above, the radiation sheet cover a current collector-side edge in a side face of the multi-cell assembly substantially entirely from one end to another end, and the radiation sheet have a tapered shape such as to gradually converge from the current collector-side edge to the opposite side edge toward the central portion of the multi-cell assembly with respect to a cell stacking direction, in order to exhibit the advantageous effects of the present invention. In addition, it is necessary that the heat absorbing sheet be disposed inside and the radiation sheet be disposed outside, in order to absorb and store the heat from the side face of the multi-cell assembly in the heat absorbing sheet and further dissipate the heat by the radiation effect of the radiation sheet. If the two sheets are disposed the other way around, almost no heat dissipation effect as described above can be obtained.

The heat absorbing sheet may be one in which silicone, acrylic, epoxy resin or rubber is prepared in a sheet shape, as in the case of the heat absorber. In this case, it is desirable to use a metal filler (such as Cu and Al) with a higher thermal conductivity as the heat conductive filler because insulation property is not required for the side face of the multi-cell assembly.

In the heat absorbers, the volume of the portion of the heat absorbers located closer to the periphery with respect to the cell stacking direction (arrangement direction) and given the least volume is set at from 10% to 50% of the volume of the portion thereof located closer to the central portion and given the greatest volume.

When the minimum volume of the portion of the heat absorbers located closer to the periphery is 10% or greater of the maximum volume thereof located closer to the central portion, the volume in the periphery region is not excessively small with respect to the volume in the central region, and sufficient heat-absorbing effect can be obtained even in the periphery. On the other hand, when the minimum volume is 50% or less, the volume thereof in the periphery region is sufficiently small with respect to the volume thereof in the central region, and the temperature distribution between the cells can be made uniform effectively.

In the radiation sheet, it is desirable that the depth of the portion thereof that covers a current collector-side edge in a side face of the multi-cell assembly substantially entirely from one end to another end be from 10% to 50% of the depth of the portion thereof that covers the central portion, with respect to the cell stacking direction, of the multi-cell assembly.

When the depth of the portion of the radiation sheet that covers a current collector-side edge in a side face of the multi-cell assembly substantially entirely from one end to another end is 10% or greater of the depth of the portion thereof that covers the central portion, with respect to the cell stacking direction, of the multi-cell assembly in the radiation sheet, the size of the radiation sheet in the periphery is not excessively small with respect to the size thereof in the central portion, so the radiation effect can be obtained sufficiently even in the periphery. Moreover, the radiation sheet can sufficiently cover the current collector-side edge in the side face of the multi-cell assembly, making it possible to inhibit the temperature increase in the connection portions of the positive and negative electrode terminals and the adjacent portions thereto effectively. On the other hand, when the depth is 50% or less, the size of the radiation sheet in the periphery is sufficiently small, so that the temperature distribution between the cells can be made uniform effectively.

When the battery module is one that is used at a high rate of 30 A or higher, particularly at a high rate of 50 A or higher or even a higher rate of 100 A or higher, the advantageous effects of the present invention can be exhibited more significantly because such a battery module is particularly more apt to show a temperature increase in the cell(s) located closer to the central portion and in the connection portions of the positive and negative electrode terminals and the adjacent portions thereto.

It is desirable that the radiation sheet be disposed on an outer side of the connection portions of the positive and negative electrode terminals.

With this configuration, heat is absorbed and stored in the heat absorbing sheet and the connection portions of the positive and negative electrode terminals and the adjacent portions thereto, and moreover, the heat is dissipated by the radiation effect of the radiation sheet. Therefore, the temperature increase can be inhibited more effectively.

In a second aspect, the present invention provides a battery module comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell;

heat absorbers each disposed in an internal space of each of connection portions of the positive and negative electrode terminals so as to be in contact with the connection portion,

wherein at least one of the heat absorbers located closer to a central portion of the multi-cell assembly with respect to the cell stacking direction has a greater volume than at least one of the heat absorbers located closer to a periphery of the multi-cell assembly; and

a heat absorbing sheet covering at least a current collector-side edge in a side face of the multi-cell assembly substantially entirely from one end to another end.

With the configuration according to the second aspect of the present invention, the temperature increase in the connection portions of the positive and negative electrode terminals and the adjacent portions thereto can be inhibited effectively because each of the heat absorbers is disposed so as to be in contact with each of the connection portions of the positive and negative electrode terminals, and the heat absorbing sheet is provided having such a shape as to cover at least a current collector-side edge in a side face of the multi-cell assembly substantially entirely from one end to another end. In other words, the heat absorbers and the heat absorbing sheet are disposed intensively in the connection portions of the positive and negative electrode terminals and the adjacent portions thereto, so that the temperature increase can be inhibited effectively. The connection portions of the positive and negative electrode terminals and the adjacent portions thereto are the locations in which the temperature tends to rise especially easily. So, if no heat dissipation means is provided, the heat from these locations can flow into the cells and cause damages to the cells. However, when the heat absorbers and the heat absorbing sheet are disposed intensively in the connection portions of the positive and negative electrode terminals and the adjacent portions thereto as in the configuration of the second aspect of the invention, the heat generated at these locations is stored (absorbed) by the heat absorbers and the heat absorbing sheet, and thereafter transmitted and dissipated to the air by radiation. Thus, the heat flow into the cells is lessened.

In addition, at least one of the heat absorbers located closer to the central portion of the multi-cell assembly with respect to the cell stacking direction has a greater volume than at least one of the heat absorbers located closer to the periphery of the multi-cell assembly. Thereby, the effect of inhibiting the temperature increase by the heat absorbers is exhibited noticeably in the central region in which the temperature rises more easily, so that the temperature distribution between the cells can be made uniform effectively. Moreover, since the volume of the heat absorbers is made smaller in the periphery region, the required amount of the heat absorbers can be saved correspondingly.

Moreover, since each of the heat absorbers is disposed in the internal space of each of the connection portions of the positive and negative electrode terminals, the heat absorbers do not occupy extra space. In other words, the internal space of each of the connection portions of the positive and negative electrode terminals, which would otherwise have been dead space, is utilized efficiently to dispose the heat absorber therein to thereby achieve the structure in which the total volume of the battery is not increased by the occupied space by the heat absorbers. Other than the heat absorbers, only the heat absorbing sheet is provided on the side face of the multi-cell assembly, and no other component for inhibiting temperature increase is additionally provided in the battery module, for example, in the space between the cells. Thus, the battery volume is not increased in effect by other components than the heat absorbers. That is, in the configuration of the second aspect of the invention, the heat absorber and the heat absorbing sheet, which are the means for inhibiting temperature increase, can effectively inhibit the temperature increase in the connection portions of the positive and negative electrode terminals and the adjacent portions thereto without, in effect, increasing the battery volume, and at the same time make the temperature distribution between the cells uniform effectively.

In the configuration according to the second aspect of the present invention, it is sufficient that the heat absorbing sheet have such a shape as to cover at least a current collector-side edge in a side face of the multi-cell assembly substantially entirely from one end to another end, and it may have the same tapered shape as the radiation sheet, for example. However, the heat absorbing sheet may have a shape such as to cover the entire side face of the multi-cell assembly (for example, a rectangular shape) so that the heat storing capability (thermal capacity) can be as high as possible.

In a third aspect, the present invention provides a battery module comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell;

a heat absorber disposed in a surrounding space around each of connection portions of the positive and negative electrode terminals so as to be in contact with the connection portion,

wherein the heat absorber has a greater volume in a central portion thereof with respect to the cell stacking direction than in a periphery thereof;

a radiation sheet disposed on a side face of the multi-cell assembly,

wherein the radiation sheet covers a current collector-side edge in a side face of the multi-cell assembly substantially entirely from one end to another end, and the radiation sheet has a tapered shape such as to gradually converge from the current collector-side edge to the opposite side edge toward a central portion of the multi-cell assembly with respect to a cell stacking direction.

In this aspect of the invention, the term “the space around the connection portions of the positive and negative electrode terminals” is meant to include the surrounding space extending around the connection portions of the positive and negative electrode terminals (in a direction perpendicular to the protruding direction of the positive and negative electrode terminals) irrespective of the structure of the connection portions of the positive and negative electrode terminals, and it is not meant to include the adjacent space to the connection portions that extends more outward (in an extending direction) than the foremost ends of the connection portions of the positive and negative electrode terminals along the protruding direction of the positive and negative electrode terminals.

In the configuration of the third aspect of the invention, the heat absorber is disposed so as to be in contact with the connection portions, and the radiation sheet has such a shape as to cover at least a current collector-side edge in a side face of the multi-cell assembly substantially entirely from one end to another end. As a result, the temperature increase in the connection portions of the positive and negative electrode terminals and the adjacent portions thereto can be inhibited effectively. In other words, the heat absorber and the radiation sheet are disposed intensively in the connection portions of the positive and negative electrode terminals and the adjacent portions thereto, so that the temperature increase can be inhibited effectively. The connection portions of the positive and negative electrode terminals and the adjacent portions thereto are the locations in which the temperature tends to rise especially easily. So, if no heat dissipation means is provided, the heat from these locations can flow into the cells and cause damages to the cells. However, when the heat absorber and the radiation sheet are disposed intensively in the connection portions of the positive and negative electrode terminals and the adjacent portions thereto as in the configuration of the third aspect of the invention, the heat generated at these locations is stored (absorbed) by the heat absorber and the radiation sheet, and thereafter transmitted and dissipated to the air by radiation. Thus, the heat flow into the cells is lessened.

In addition, the heat absorber has a greater volume in a central portion thereof with respect to the cell stacking direction than in a periphery thereof, and the radiation sheet has a tapered shape such as to gradually converge from the current collector-side edge to the opposite side edge toward the central portion of the multi-cell assembly with respect to the cell stacking direction. Thereby, the effect of inhibiting the temperature increase by the heat absorber and the radiation sheet is exhibited noticeably in the central region in which the temperature can rise more easily, so that the temperature distribution between the cells can be made uniform effectively. Moreover, since the volume of the heat absorber and that of the radiation sheet are smaller in the periphery region, the required amount of the heat absorber and that of the radiation sheet can be saved correspondingly.

Moreover, since the heat absorber is disposed in a surrounding space around each of the connection portions of the positive and negative electrode terminals, the heat absorber does not occupy extra space. In other words, the surrounding space around each of the connection portions of the positive and negative electrode terminals, which would otherwise have been dead space, is utilized efficiently to dispose the heat absorber therein to thereby achieve the structure in which the total volume of the battery is not increased by the occupied space by the heat absorber. Other than the heat absorber, only the radiation sheet is provided on the side face of the multi-cell assembly, and no other component for inhibiting temperature increase is additionally provided in the battery module, for example, in the space between the cells. Thus, the battery volume is not increased in effect by other components than the heat absorber. That is, in the configuration of the third aspect of the invention, the heat absorber and the radiation sheet, which are the means for inhibiting temperature increase, can effectively inhibit the temperature increase in the connection portions of the positive and negative electrode terminals and the adjacent portions thereto without, in effect, increasing the battery volume, and at the same time make the temperature distribution between the cells uniform effectively.

In a fourth aspect, the present invention provides a battery module comprising:

a multi-cell assembly comprising a plurality of cells stacked to each other, each cell having a positive electrode terminal and a negative electrode terminal connected in series or in parallel respectively to a positive electrode terminal and a negative electrode terminal of an adjacent cell;

a heat absorber disposed in a surrounding space around each of connection portions of the positive and negative electrode terminals so as to be in contact with the connection portion,

wherein the heat absorber has a greater volume in a central portion thereof with respect to the cell stacking direction than in a periphery thereof; and

a heat absorbing sheet covering at least a current collector-side edge in a side face of the multi-cell assembly substantially entirely from one end to another end.

With the configuration according to the fourth aspect of the present invention, the temperature increase in the connection portions of the positive and negative electrode terminals and the adjacent portions thereto can be inhibited effectively because the heat absorber is disposed so as to be in contact with the connection portions, and the heat absorbing sheet is provided having such a shape as to cover at least a current collector-side edge in a side face of the multi-cell assembly substantially entirely from one end to another end. In other words, the heat absorber and the heat absorbing sheet are disposed intensively in the connection portions of the positive and negative electrode terminals and the adjacent portions thereto, so that the temperature increase can be inhibited effectively. The connection portions of the positive and negative electrode terminals and the adjacent portions thereto are the locations in which the temperature tends to rise especially easily. So, if no heat dissipation means is provided, the heat from these locations can flow into the cells and cause damages to the cells. However, when the heat absorber and the heat absorbing sheet are disposed intensively in the connection portions of the positive and negative electrode terminals and the adjacent portions thereto as in the configuration of the fourth aspect of the invention, the heat generated at these locations is stored (absorbed) by the heat absorber and the heat absorbing sheet, and thereafter transmitted and dissipated to the air by radiation. Thus, the heat flow into the cells is lessened.

In addition, the heat absorber has a greater volume in the central portion thereof with respect to the cell stacking direction of the multi-cell assembly than the periphery thereof. Thereby, the effect of inhibiting the temperature increase by the heat absorber is exhibited noticeably in the central region in which the temperature can rise more easily, so that the temperature distribution between the cells can be made uniform effectively. Moreover, since the volume of the heat absorber is made smaller in the periphery region, the required amount of the heat absorber can be saved correspondingly.

Moreover, since the heat absorber is disposed in a surrounding space around each of the connection portions of the positive and negative electrode terminals, the heat absorber does not occupy extra space. In other words, the surrounding space around each of the connection portions of the positive and negative electrode terminals, which would otherwise have been dead space, is utilized efficiently to dispose the heat absorber therein to thereby achieve the structure in which the total volume of the battery is not increased by the occupied space by the heat absorber. Other than the heat absorber, only the heat absorbing sheet is provided on the side face of the multi-cell assembly, and no other component for inhibiting temperature increase is additionally provided in the battery module, for example, in the space between the cells. Thus, the battery volume is not increased in effect by other components than the heat absorber. That is, in the configuration of the fourth aspect of the invention, the heat absorber and the heat absorbing sheet, which are the means for inhibiting temperature increase, can effectively inhibit the temperature increase in the connection portions of the positive and negative electrode terminals and the adjacent portions thereto without, in effect, increasing the battery volume, and at the same time make the temperature distribution between the cells uniform effectively.

In the configuration according to the fourth aspect of the present invention, it is sufficient that the heat absorbing sheet have such a shape as to cover at least a current collector-side edge in a side face of the multi-cell assembly substantially entirely from one end to another end, and it may have the same tapered shape as the radiation sheet, for example. However, the heat absorbing sheet may have a shape such as to cover the entire side face of the multi-cell assembly (for example, a rectangular shape) so that the heat storing capability (thermal capacity) can be as high as possible.

### DESCRIPTION OF PREFERRED EMBODIMENTS

Hereinbelow, with reference to the drawings, the present invention is described in further detail based on certain embodiments and examples thereof. It should be construed, however, that the present invention is not limited to the following embodiments and examples, and various changes and modifications are possible without departing from the scope of the invention.

### Preparation of Cell

A positive electrode and a negative electrode were prepared using LiCoO₂ as the positive electrode active material, an aluminum foil as the positive electrode current collector, carbon as the negative electrode active material, and a copper foil as the negative electrode current collector. The positive electrode and the negative electrode were cut into predetermined dimensions, and positive and negative electrode tabs for current collection were formed by extending the active material-uncoated portions of the current collectors.

The resulting positive and negative electrodes were stacked with a separator interposed therebetween, and they were stacked in the following order: positive electrode, separator, negative electrode, separator, and so on. Both outermost layers of the stack were negative electrodes, and 20 sheets of positive electrodes and 21 sheets of negative electrodes were stacked.

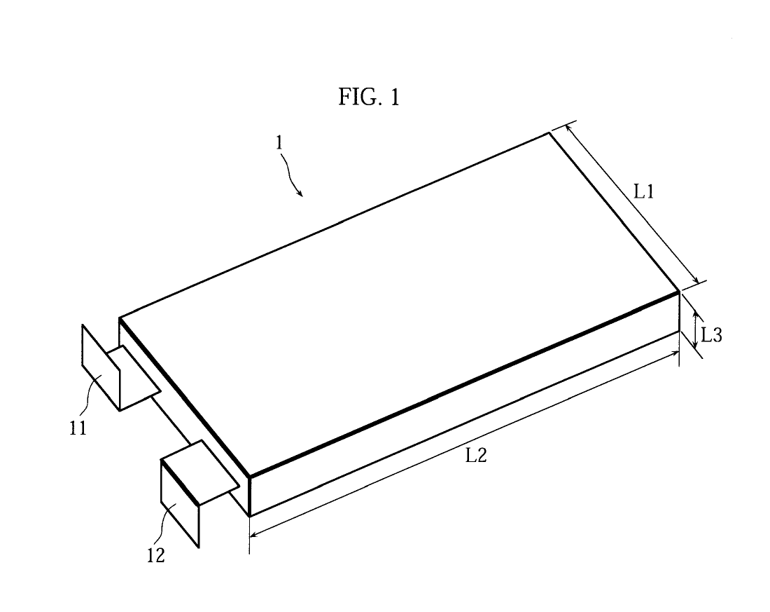

The positive and negative electrode tabs of the stacked positive and negative electrodes were welded respectively to a positive electrode terminal 11 made of aluminum and a negative electrode terminal 12 made of copper by ultrasonic welding. The width of each of the positive and negative electrode terminals 11 and 12 was 56 mm, and the thickness thereof was 0.8 mm. The stacked electrode assembly to which the positive and negative electrode terminals 11 and 12 were attached was placed in an aluminum laminate battery case, and an electrolyte solution was filled therein. Thereafter, an end of the battery case was thermally bonded to seal the battery. Thus, a cell 1 as shown in FIG. 1, which was a lithium-ion battery, was prepared.

The dimensions of the obtained cell 1 are: width L1=60 mm, length L2=160 mm, and thickness L3=8 mm, as illustrated in FIG. 1. The positive electrode terminal 11 and the negative electrode terminal 12 protrude from the same heightwise upper portion (the bottom left end face in FIG. 1) from the positions 8 mm inward from the opposite widthwise ends. The protruding end portions of the positive electrode terminal 11 and the negative electrode terminal 12 are bent in opposite directions to each other (upward and downward in FIG. 1) at a right angle. The protruding height is 8 mm from the heightwise end (the bottom left end face in FIG. 1) of the cell.

### Preparation of Multi-Cell Assembly

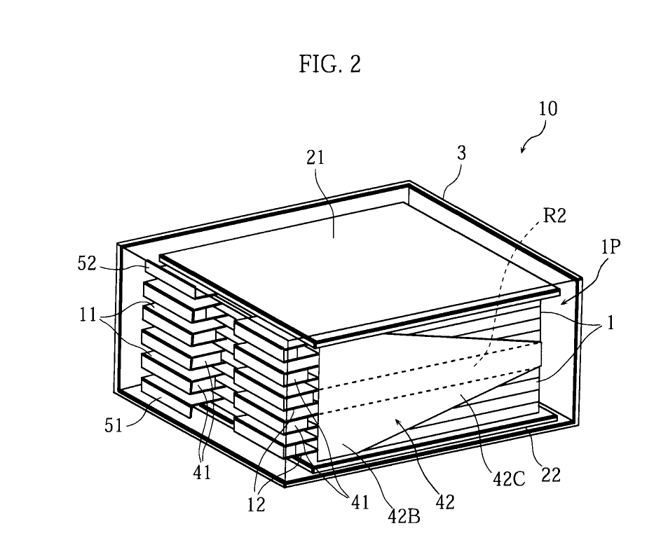

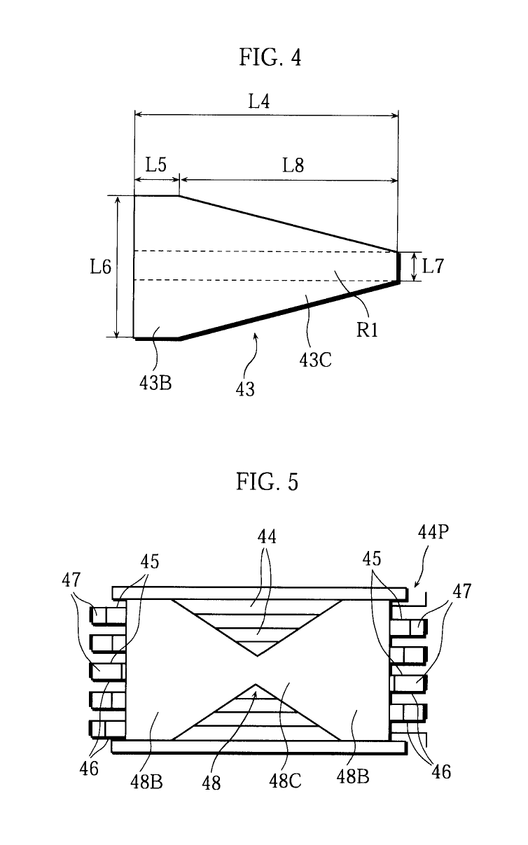

As illustrated in FIG. 2, 10 cells of the just-described cell 1 were prepared, and they were stacked in a thickness (L3) direction (in a vertical direction in FIG. 2). A top plate 21 and a bottom plate 22, both made of a resin and having a width of 86 mm, a length of 188 mm, and a thickness of 12 mm, were disposed on the opposite end faces (the upper and lower end faces in FIG. 2) so as to press the cells 1 from outside (from the top and bottom in FIG. 2). A later-described heat absorbing sheet 43 (see FIG. 4) and a later-described radiation sheet 42 were affixed to both side faces (the front and rear side faces in FIG. 2) in that order. The positive electrode terminals 11 and the negative electrode terminal 12 of the 10 cells 1 were connected respectively in series while later-described heat absorbers 41 were fitted and secured inside. A positive electrode connecting terminal 51 and a negative electrode connecting terminal 52, each made of carbon steel, were connected respectively to the ends of the current conduction path. Thereby, a multi-cell assembly 1P was prepared having a width of 160 mm, a length of 160 mm, (168 mm including the positive and negative electrode terminals 11 and 12), and a thickness of 8 mm×10 cells=80 mm.

### Preparation of Heat Absorber

A silicone rubber (polymer) containing aluminum nitride as the heat conductive filler and having a thermal conductivity of 1.35 W/m·K and heat absorbing capability (heat storage capability) was formed into three kinds of rectangular parallelepiped shapes having the following dimensions, to prepare a large-sized heat absorber 41L, a middle-sized heat absorber 41M, and a small-sized heat absorber 41S.

Large-sized heat absorber 41L: 56 mm×20 mm×8 mm

Middle-sized heat absorber 41M: 56 mm×15 mm×8 mm

Small-sized heat absorber 41S: 56 mm×10 mm×8 mm

### Placing and Fastening Heat Absorber

As illustrated in FIG. 2, the positive electrode terminals 11 and the negative electrode terminals 12 of the adjacent cells 1 were joined to each other by superimposing the foremost ends of the bent portions with each other, to thereby form the connection portions each having an angular C-shape as viewed from side. Here, a screw through hole had been formed in each of the bent portions of the positive electrode terminals 11 and the negative electrode terminals 12, and a screw hole (not shown) had been formed in the heat absorber 41. The heat absorber 41 was inserted in the connection portion of the positive and negative electrode terminals 11 and 12, and the bent portions of the positive electrode terminal 11 and the negative electrode terminal 12 were screw-fastened together with the heat absorber 41 by a screw (not shown). That is, using the heat absorber 41 disposed inside the connection portion of the positive and negative electrode terminals 11 and 12 as a nut, a screw was screwed in from an outside of the connection portion of the positive and negative electrode terminals 11 and 12 to join the bent portions of the positive electrode terminal 11 and the negative electrode terminal 12 by screw-fastening.

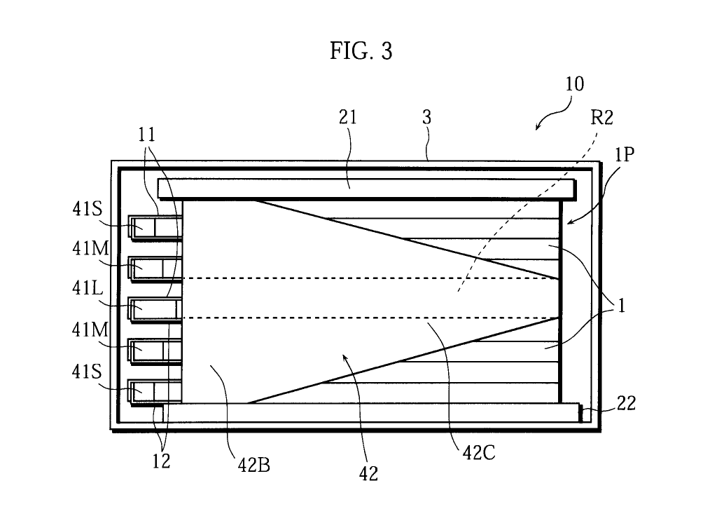

At that time, as illustrated in FIG. 3, the large-sized heat absorber 41L was disposed in the connection portion of the positive and negative electrode terminals 11 and 12 located closest to the center of the multi-cell assembly 1P with respect to the stacking direction (arrangement direction) of the cells 1 of the multi-cell assembly 1P. The middle-sized heat absorbers 41M were disposed in the connection portions of the positive and negative electrode terminals 11 and 12 on the opposite sides of and adjacent to the foregoing positive and negative electrode terminals 11 and 12. The small-sized heat absorbers 41S were disposed in the connection portions of the positive and negative electrode terminals 11 and 12 on the further opposite sides of and adjacent to the foregoing positive and negative electrode terminals 11 and 12.

The small-sized heat absorbers 41S are located in the periphery, the middle-sized heat absorbers 41M are located closer to the central portion than the small-sized heat absorbers 41S, and the large-sized heat absorber 41L is located closer to the central portion than the middle-sized heat absorbers 41M (i.e., closest to the central portion). Thus, the heat absorbers 41 are disposed so that the volume gradually increases in the ratio 2:3:4 from the periphery to the center.

### Preparation of Heat Absorbing Sheet

A silicone rubber (polymer) containing Cu as the heat conductive filler and having a thermal conductivity of 4.5 W/m·K and heat absorbing capability (heat storage capability) was formed into a polygonal-shaped sheet having a thickness of 3.0 mm as shown in FIG. 4, to obtain a heat absorbing sheet 43. As shown in the figure, the heat absorbing sheet 43 has a total length L4 of 160 mm and extends slightly longer in one direction. It is formed in a hexagonal shape as a whole and is provided with a current collector-side cover portion 43B and a partial cover portion 43C integral with each other.

The current collector-side cover portion 43B is in a rectangular shape having a length (vertical length) L5 of 48 mm from one end (the left end in FIG. 4) and a width (horizontal width) L6 of 80 mm. The partial cover portion 43C is in a trapezoidal shape having a height L8 of 112 mm and a lower base (L6=80 mm), which is one of the longer sides of the current collector-side cover portion 43B, and the opposite sides thereof (the upper and lower sides in FIG. 4) extend to an upper base (L7=16 mm) symmetrically in a tapered manner. Specifically, the heat absorbing sheet 43 has a strip-shaped region R1, which is located at the central portion with respect to the width L6 and has a width L7 of 16 mm and a length L4 of 160 mm. The strip-shaped region R1 covers, from a side face, substantially entirely the two cells 1 (thickness L3×2=8 mm×2=16 mm) that are located closest to the center with respect to the stacking direction (arrangement direction) of the cells 1 of the multi-cell assembly 1P. In a portion of the heat absorbing sheet 43, the strip-shaped region R1 and the opposite side regions across the region R1 form a trapezoidal shape tapered from the current collector-side cover portion 43B toward one end (the right end in FIG. 4). Thereby, the heat absorbing sheet 43 has such a shape that its area increases proportionally from both peripheral portions toward the central region R1, in other words, such a shape that the area in which the cells 1 are exposed increases proportionally from the central region R1 toward both peripheral portions.

### Placing and Affixing Heat Absorbing Sheet

An adhesive layer was provided on one surface of the heat absorbing sheet 43, and the heat absorbing sheet 43 was affixed (not shown) to each of the side faces of the multi-cell assembly 1P so that the current collector-side edge was covered by the current collector-side cover portion 43B.

### Preparation of Radiation Sheet

A sheet with an emissivity ε (thermal emissivity) of 0.90 and thickness of 1.7 mm, prepared using glass fabric as the core material and containing alumina as the heat conductive filler fixed thereon by a resin, was cut in the same shape and the same dimensions as those of the above-described heat absorbing sheet 43, to obtain a radiation sheet 42 shown in FIGS. 2 and 3. That is, like the heat absorbing sheet 43, the radiation sheet 42 has a total length L4 of 160 mm and extends slightly longer in one direction. It is formed in a hexagonal shape as a whole and is provided with a current collector-side cover portion 42B and a partial cover portion 42C integral with each other. The current collector-side cover portion 42B is in a rectangular shape having a length (vertical length) L5 of 48 mm from one end (the left end in FIGS. 2 and 3) and a width (horizontal width) L6 of 80 mm. The partial cover portion 42C is in a trapezoidal shape having a height L8 of 112 mm and a lower base (L6=80 mm), which is one of the longer sides of the current collector-side cover portion 42B, and the opposite sides thereof (the upper and lower sides in FIGS. 2 and 3) extend to an upper base (L7=16 mm) symmetrically in a tapered manner. The radiation sheet 42 has a strip-shaped region R2, which is located at the central portion with respect to the width L6 and has a width L7 of 16 mm and a length L4 of 160 mm. The strip-shaped region R2 covers, from a side face, substantially entirely the two cells 1 (thickness L3×2=8 mm×2=16 mm) that are located closest to the center with respect to the stacking direction (arrangement direction) of the cells 1 of the multi-cell assembly 1P. In a portion of the radiation sheet 42, the strip-shaped region R2 and the opposite side regions across the region R2 form a trapezoidal shape tapered from the current collector-side cover portion 42B toward one end (the right end in FIGS. 2 and 3). Thereby, the radiation sheet 43 has such a shape that its area increases proportionally from both peripheral portions toward the central region R2, in other words, such a shape that the area in which the cells 1 are exposed increases proportionally from the central region R2 toward both peripheral portions.

### Placing and Affixing Heat Absorbing Sheet

An adhesive layer was provided on one surface of the radiation sheet 42, and the radiation sheet 43 was affixed to the outer side face (the side face on which no adhesive layer was provided) of each of the heat absorbing sheets 43 on both sides so that the contours of the two sheets are in agreement with each other. Thus, as illustrated in FIGS. 2 and 3, the radiation sheets 42 were disposed and fixed on both side faces of the multi-cell assembly 1P with the heat absorbing sheets 43 interposed. In order to facilitate the work, the radiation sheet 42 was affixed to the outer side face of the heat absorbing sheet 43 in advance to form a laminate sheet, and the resulting laminate sheet was affixed to each of the opposite side faces of the multi-cell assembly 1P.

### Preparation of Battery Module

The obtained multi-cell assembly 1P was enclosed in a case 3 having a width of 96 mm, a length of 198 mm, and a thickness of 114 mm and made of resin, to obtain a battery module 10 as shown in FIGS. 2 and 3.

### EXAMPLES

### Example 1

A battery module fabricated in the same manner as described in the foregoing embodiment was used as the battery module of this example.

The battery module fabricated in this manner is hereinafter referred to as a battery module A1 of the invention.

### Example 2

A battery module was fabricated in the same manner as in the case of the foregoing battery module A1 of the invention, except that no radiation sheet was provided.

The battery module fabricated in this manner is hereinafter referred to as a battery module A2 of the invention.

### Example 3

A battery module was fabricated in the same manner as in the case of the foregoing battery module A1 of the invention, except that no heat absorbing sheet was provided.

The battery module fabricated in this manner is hereinafter referred to as a battery module A3 of the invention.

### Comparative Example

A battery module was fabricated in the same manner as in the case of the foregoing battery module A1 of the invention, except that none of the heat absorber, the heat absorbing sheet, or the radiation sheet was provided.

The battery module fabricated in this manner is hereinafter referred to as a comparative battery module Z.

### Evaluation Test for Battery Module

Each of the battery modules A1, A2, and A3 and the comparative battery module Z was placed in a thermostatic chamber. Each of the battery modules was charged at 1.0 It (100 A) and discharged at 2.0 It (200 A), and the temperature increase during the discharge was measured for each of the battery modules.

### Results of the Experiment

The results were as follows. With the comparative battery module Z, the battery temperature just after the discharge was increased from 18° C. to the maximum of 29° C., and the temperature variation between the cells 1 was about 3° C. In contrast, with the battery modules A1, A2, and A3 of the invention, the battery temperature was increased from 18° C. to the maximum of 28° C. during the discharge at 2.0 It, and the temperature variation between the cells 1 was 2° C. or less.

### Analysis of the Results

It is believed that in the battery modules A1, A2, and A3 of the invention, an abrupt temperature increase was alleviated by the heat absorbers 41 and at least one of the heat absorbing sheet 43 and the radiation sheet 42 even within a sealed space, and heat dissipation was promoted particularly significantly in the cells 1 located at the center by the heat dissipation from the heat absorbers 41 and at least one of the heat absorbing sheet 43 and the radiation sheet 42.

### Advantageous Effects Obtained by the Battery Module of the Invention

In each of the battery modules A1 and A3 of the invention, the multi-cell assembly 1P comprises a plurality of cells 1 (10 cells) stacked to each other, each cell 1 having a positive electrode terminal 11 and a negative electrode terminal 11 connected in series or in parallel respectively to a positive electrode terminal 11 and a negative electrode terminal 12 of an adjacent cell 1. Each of the heat absorbers 41 is disposed in the internal space of each of the connection portions of the positive and negative electrode terminals 11 and 12 so as to be in contact with the connection portion. At least one of the heat absorbers 41 located closer to the central portion of the multi-cell assembly with respect to the stacking direction (arrangement direction) of the cells 1 has a greater volume than at least one of the heat absorbers 41 located closer to the periphery of the multi-cell assembly. The radiation sheet 42 is disposed on a side face of the multi-cell assembly 1P. The radiation sheet 42 covers the current collector-side edge in a side face of the multi-cell assembly 1P substantially entirely from one end to another end, and the radiation sheet 42 has a tapered shape such as to gradually converge from the current collector-side edge to the opposite side edge (the right side edge in FIGS. 2 and 3) toward the central portion of the multi-cell assembly 1P with respect to the stacking direction (arrangement direction) of the cells 1.

In the configurations of the battery modules A1 and A3 of the invention, each of the heat absorbers 41 is disposed in the internal space of each of the connection portions of the positive and negative electrode terminals 11 and 12 so as to be in contact with the connection portion, and the radiation sheet 42 has such a shape as to cover at least the current collector-side edge in a side face of the multi-cell assembly 1P substantially entirely from one end to another end (from the upper end to the lower end in FIGS. 2 and 3), i.e., a shape having the current collector-side cover portion 42B. As a result, the temperature increase in the connection portions of the positive and negative electrode terminals 11 and 12 and the adjacent portions thereto can be inhibited effectively. In other words, the heat absorbers 41 and the radiation sheet 42 are disposed intensively in the connection portions of the positive and negative electrode terminals 11 and 12 and the adjacent portions thereto, so that the temperature increase can be inhibited effectively. The connection portions of the positive and negative electrode terminals 11 and 12 and the adjacent portions thereto are the locations in which the temperature tends to increase especially easily. So, if no heat dissipation means is provided, the heat from these locations can flow into the cells and cause damages to the cells. However, when the heat absorbers 41 and the radiation sheet 42 are disposed intensively in the connection portions of the positive and negative electrode terminals 11 and 12 and the adjacent portions thereto as described above, the heat generated at these locations is stored (absorbed) by the heat absorbers 41 and the radiation sheet 42, and thereafter transmitted and dissipated to the air by radiation. Thus, the heat flow into the cells is lessened.

In addition, at least one of the heat absorbers 41 located closer to the central portion of the multi-cell assembly with respect to the stacking direction (arrangement direction) of the cells 1 has a greater volume than at least one of the heat absorbers 41 located closer to the periphery of the multi-cell assembly, and the radiation sheet 42 has a tapered shape such as to gradually converge from the current collector-side edge to the opposite side edge toward the central portion of the multi-cell assembly with respect to the stacking direction (arrangement direction) of the cells 1. Thereby, the effect of inhibiting the temperature increase by the heat absorbers 41 and the radiation sheet 42 is exhibited noticeably in the central region in which the temperature can rise more easily, so that the temperature distribution between the cells 1 can be made uniform effectively. Moreover, since the volume of the heat absorbers 41 and that of the radiation sheet 42 are smaller in the periphery region, the required amount of the heat absorbers 41 and that of the radiation sheet 42 can be saved correspondingly.

Moreover, since each of the heat absorbers 41 is disposed in the internal space of each of the connection portions of the positive and negative electrode terminals 11 and 12, the heat absorbers 41 do not occupy extra space. In other words, the internal space of each of the connection portions of the positive and negative electrode terminals 11 and 12, which would otherwise have been dead space, is utilized efficiently to dispose the heat absorber 41 therein to thereby achieve the structure in which the total volume of the battery module 10 (the multi-cell assembly 1P) is not increased by the occupied space by the heat absorbers 41. Other than the heat absorbers 41, only the radiation sheet 42 (and the heat absorbing sheet 43) is provided on the side face of the multi-cell assembly 1P, and no other component for inhibiting temperature increase is additionally provided in the battery module 10, for example, in the space between the cells 1. Thus, the volume of the battery module 10 (the multi-cell assembly 1P) is not increased in effect by other components than the heat absorbers 41. That is, in the above-described configurations of the battery modules A1 and A3 of the invention, the heat absorbers 41 and the radiation sheet 42, which are the means for inhibiting temperature increase, can effectively inhibit the temperature increase in the connection portions of the positive and negative electrode terminals 11 and 12 and the adjacent portions thereto without, in effect, increasing the volume of the battery module 10 (the multi-cell assembly 1P), and at the same time can make the temperature distribution between the cells 1 uniform effectively.

In the configuration of the battery module A1 of the invention, the heat absorbing sheet 43 is disposed between the radiation sheet 42 and the side face of the multi-cell assembly 1P. As a result, heat is absorbed and stored in the heat absorbing sheet 43 from the side face of the multi-cell assembly 1P, and moreover, the heat is dissipated by the radiation effect of the radiation sheet 42. Therefore, the temperature increase can be inhibited more effectively.

In the configurations of the battery modules A1 and A3 of the invention, the volume of the portion of the heat absorbers 41 located closer to the periphery with respect to the stacking direction (arrangement direction) of the cells 1 and given the least volume, i.e., the volume of the small-sized heat absorbers 41S, is set at 50% of the volume of the portion thereof located closer to the central portion and given the greatest volume, i.e., the volume of the large-sized heat absorber 41L. Therefore, the volume in the periphery region is not excessively small with respect to the volume in the central region, so sufficient heat-absorbing effect can be obtained even in the periphery. At the same time, the volume in the periphery region is sufficiently small with respect to the volume in the central region, so the temperature distribution between the cells 1 can be made uniform effectively.

Moreover, the depth L5 of the portion of the radiation sheet 42 that covers the current collector-side edge in a side face of the multi-cell assembly 1P substantially entirely from one end to another end, i.e., the depth L5 of the current collector-side cover portion 42B, is set at 30% of the depth L4 of the portion of the radiation sheet 42 that covers the central portion with respect to the stacking direction of the cells 1, i.e., the depth L4 of the central region R2 of the radiation sheet 42. Therefore, the size of the radiation sheet in the periphery is not excessively small with respect to the size thereof in the central portion, so the radiation effect can be obtained sufficiently even in the periphery. Moreover, the radiation sheet 42 (the current collector-side cover portion 42B thereof) can sufficiently cover the current collector-side edge in a side face of the multi-cell assembly 1P, making it possible to inhibit the temperature increase in the connection portions of the positive and negative electrode terminals 11 and 12 and the adjacent portions thereto effectively. Furthermore, the size of the radiation sheet in the periphery is sufficiently small with respect to the size thereof in the central portion, so that the temperature distribution between the cells 1 can be made uniform effectively.

In addition, the battery modules A1 and A3 of the invention are used at a current of 200 A. When the battery module is used at such a high current, the battery module is particularly apt to show the temperature rise in the cells located in the central portion and in the connection portions of the positive and negative electrode terminals as well as the adjacent portions thereto. Therefore, the advantageous effects of the present invention can be exhibited particularly noticeably in the battery modules A1 and A3 of the invention.

In each of the battery modules A1 and A2 of the invention, the multi-cell assembly 1P comprises a plurality of cells 1 (10 cells) stacked to each other, each cell 1 having a positive electrode terminal 11 and a negative electrode terminal 11 connected in series or in parallel respectively to a positive electrode terminal 11 and a negative electrode terminal 12 of an adjacent cell 1. Each of the heat absorbers 41 is disposed in the internal space of each of the connection portions of the positive and negative electrode terminals 11 and 12 so as to be in contact with the connection portion. At least one of the heat absorbers 41 located closer to the central portion of the multi-cell assembly with respect to the stacking direction (arrangement direction) of the cells 1 has a greater volume than at least one of the heat absorbers 41 located closer to the periphery of the multi-cell assembly. The heat absorbing sheet 43 is provided that has such a shape as to cover at least the current collector-side edge in a side face of the multi-cell assembly 1P substantially entirely from one end to another end (from the upper end to the lower end in FIGS. 2 and 3), i.e., a shape having the current collector-side cover portion 43B.

With the configurations of the battery modules A1 and A2 of the invention, the temperature increase in the connection portions of the positive and negative electrode terminals 11 and 12 and the adjacent portions thereto can be inhibited effectively because each of the heat absorbers 41 is provided so as to be in contact with each of the connection portions of the positive and negative electrode terminals 11 and 12, and the heat absorbing sheet 43 is provided having such a shape as to cover at least the current collector-side edge in a side face of the multi-cell assembly 1P substantially entirely from one end to another end. In other words, the heat absorbers 41 and the heat absorbing sheet 43 are disposed intensively in the connection portions of the positive and negative electrode terminals 11, 12 and the adjacent portions thereto, so that the temperature increase can be inhibited effectively. The connection portions of the positive and negative electrode terminals 11 and 12 and the adjacent portions thereto are the locations in which the temperature tends to increase especially easily. So, if no heat dissipation means is provided, the heat from these locations can flow into the cells 1 and cause damages to the cells 1. However, when the heat absorbers 41 and the heat absorbing sheet 43 are disposed intensively in the connection portions of the positive and negative electrode terminals 11 and 12 and the adjacent portions thereto as described above, the heat generated at these locations is stored (absorbed) by the heat absorbers 41 and the heat absorbing sheet 43, and thereafter transmitted and dissipated to the air by radiation. Thus, the heat flow into the cells 1 is lessened.

In addition, at least one of the heat absorbers 41 located closer to the central portion of the multi-cell assembly with respect to the stacking direction (arrangement direction) of the cells 1 has a greater volume than at least one of the heat absorbers 41 located closer to the periphery of the multi-cell assembly. Thereby, the effect of inhibiting the temperature increase by the heat absorbers 41 is exhibited significantly in the central region in which the temperature can rise more easily, so that the temperature distribution between the cells 1 can be made uniform effectively. Moreover, since the volume of the heat absorbers 41 is made smaller in the periphery region, the required amount of the heat absorbers 41 can be saved correspondingly.

Moreover, since each of the heat absorbers 41 is disposed in the internal space of each of the connection portions of the positive and negative electrode terminals 11 and 12, the heat absorbers 41 do not occupy extra space. In other words, the internal space of each of the connection portions of the positive and negative electrode terminals 11 and 12, which would otherwise have been dead space, is utilized efficiently to dispose the heat absorber therein to thereby achieve the structure in which the total volume of the battery is not increased by the occupied space by the heat absorbers 41. Other than the heat absorbers 41, only the heat absorbing sheet 43 (and the radiation sheet 42 in the battery module A1 of the invention) is provided on the side face of the multi-cell assembly 1P, and no other component for inhibiting temperature increase is additionally provided in the battery module 10, for example, in the space between the cells 1. Thus, the volume of the battery module is not increased in effect by other components than the heat absorbers 41. That is, in the above-described configuration of each of the battery modules A1 and A2 of the invention, the heat absorbers 41 and the heat absorbing sheet 43, which are the means for inhibiting temperature increase, can effectively inhibit the temperature increase in the connection portions of the positive and negative electrode terminals 11 and 12 and the adjacent portions thereto without, in effect, increasing the volume of the battery module and at the same time make the temperature distribution between the cells 1 uniform effectively.

The heat absorbing sheet may have a shape such as to entirely cover the side face of the multi-cell assembly (for example, a rectangular shape) so that the heat storing capability (thermal capacity) can be as high as possible. However, the heat absorbing sheet 43 in the battery modules A1 and A2 of the invention has the same tapered shape as that of the radiation sheet 42, so the required amount of the heat absorbing sheet 43 is saved correspondingly.

### Other Embodiments

(1) In the battery module A1, the positive electrode terminals 11 and the negative electrode terminals 12 protrude in the same direction from the multi-cell assembly 1P. However, it is possible to employ a configuration in which the positive electrode terminals and the negative electrode terminals may protrude in different directions. In this case, there are a plurality of current collector-side edges in a side face of the multi-cell assembly. FIG. 5 shows a schematic view illustrating one example of the multi-cell assembly having a structure in which the positive electrode terminal and the negative electrode terminals protrude in opposite directions from the multi-cell assembly. A multi-cell assembly 44P shown in the figure has a plurality of cells 44 (10 cells) stacked to each other, and positive electrode terminals 45 and negative electrode terminals 46 protruding in opposite directions and being connected in series. Accordingly, both of the opposite side edges in a side face of the multi-cell assembly 44P are the current collector-side edges. Heat absorbers 47 are disposed in the connection portions the positive and negative electrode terminals 45 and 46, in the same manner as described in the case of the battery module A1 of the invention. Laminate sheets 48 are disposed on both opposite side faces of the multi-cell assembly 44P. Each of the laminate sheet 48 is formed by bonding a heat absorbing sheet and a radiation sheet having the same shape and the same dimensions to each other. In both of the opposite peripheral portions, respective current collector-side cover portions 48B are formed, and a partial cover portion 48C is formed in such a shape as to be narrower in width gradually from both the current collector-side cover portions 48B toward the center, that is, in such a shape that the central portion is narrowed so as to be dented from both widthwise sides (both vertical sides in FIG. 5) as a whole. The laminate sheet 48 covers the current collector-side edges on both the shorter edges in a side face of the multi-cell assembly 44P substantially entirely from one end to another end with the two current collector-side cover portions 48B, and the laminate sheet 48 has a tapered shape such as to gradually converge from one of the current collector-side edges 48B to the opposite side edge (from the left current collector-side edge 48B to the right current collector-side edge, or from the right current collector-side edge 48B to the left current collector-side edge, in FIG. 5) toward the central portion of the multi-cell assembly 44P with respect to the cell stacking direction (arrangement direction) of the cells 44. Therefore, as in the case of the battery module A1 of the invention, the temperature increase in the connection portions of the positive and negative electrode terminals 45 and 46 and the adjacent portions thereto is inhibited effectively, and at the same time, the effect of inhibiting the temperature increase is exhibited in the central region in which the temperature tends to rise easily. As a result, the temperature distribution between the cells 44 is made uniform effectively.

(2) In the battery module A1 of the invention, a plurality of cells 1 (10 cells) are connected in series. However, it is possible to employ a configuration in which a plurality of cells are connected in parallel. When a bass bar or the like is used to connect the positive electrode terminals of a large number of cells to each other and the negative electrode terminals of a large number of cells to each other in this case, the bass bar or the like is also included in the connection portions of the positive and negative electrode terminals.

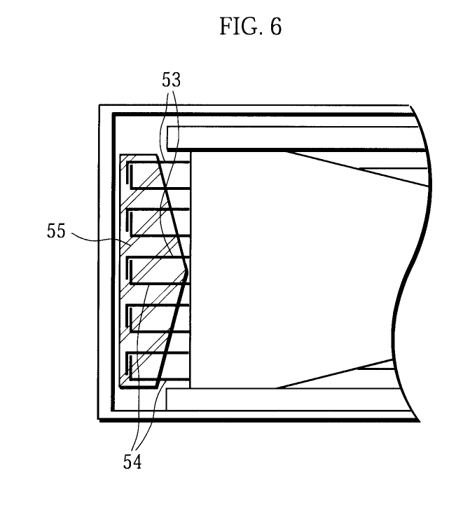

(3) In the battery module A1 of the invention, the heat absorbers 41 are disposed inside the connection portions of the positive and negative electrode terminals 11 and 12. However, a heat absorber may be disposed in a surrounding space around the connection portions of the positive and negative electrode terminals, instead of providing the heat absorbers inside the connection portions of the positive and negative electrode terminals or in addition to providing the heat absorbers inside the connection portions of the positive and negative electrode terminals. FIG. 6 illustrates an example in which the heat absorbers are disposed in the internal space of, and the surrounding space around, each of the connection portions of the positive and negative electrode terminals. In the example shown in the figure, positive electrode terminals 53 and negative electrode terminals 54 are connected to each other so as to form a structure having an angular C-shape as viewed from side, and a heat absorbing resin is integrally formed so that both the internal space of and the surround space around each of the connection portions of the positive and negative electrode terminals 53 and 54 are filled continuously, whereby a heat absorber 55 is formed. The heat absorber 55 is formed so that its thickness gradually increases from the periphery to the central portion, in other words, it has a greater volume in a central portion thereof with respect to the cell stacking direction than in a periphery thereof. With this configuration of the heat absorber 55, the temperature increase in the connection portions of the positive and negative electrode terminals 53 and 54 and the adjacent portions thereto can be inhibited more effectively by utilizing the internal space of and the surrounding space around the connection portions of the positive and negative electrode terminals 53 and 54 more effectively, although the formation of the heat absorber involves slightly more difficulties. It is also possible to provide heat absorbers individually both for the internal space of each of the connection portions of the positive and negative electrode terminals and for the surrounding space therearound. Thereby, the formation of the heat absorbers can be made more easily.

(4) In the battery module A1 of the invention, the case 3 is made of a resin. However, the case may be formed of a metal or an alloy that has heat transmission capability, for example. It is also possible to provide the radiation sheet on the inner surface of the case made of a metal or an alloy. This configuration enables the case itself to have heat dissipation capability for releasing heat effectively to outside. Therefore, the heat dissipation effect of the battery module can be further improved.

(5) In the battery module A1 of the invention, the heat absorbers 41 are screw-fastened. However, the heat absorbers 41 may be fastened by bonding with an adhesive or the like. In that case, the heat absorbers may be inserted and fixed inside the connection portions of the positive and negative electrode terminals while the connection portions of the positive and negative electrode terminals are being constructed.

(6) The heat absorber(s) may be brought into contact with the case by allowing the heat absorber(s) to protrude further from the inside of each of the connection portions of the positive and negative electrode terminals. This enhances the heat dissipation effect further. Alternatively, it is possible to provide the radiation sheet on the inner surface of the case so that it can receive the heat from the heat absorber(s) and release it to outside.

(7) The positive electrode active material is not limited to lithium cobalt oxide.

Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(8) Other than graphite such as natural graphite and artificial graphite, various materials may be employed as the negative electrode active material, as long as the material is capable of intercalating and deintercalating lithium ions. Examples include coke, tin oxides, metallic lithium, silicon, and mixtures thereof

(9) The electrolyte is not particularly limited either. Examples of the usable lithium salt include LiBF₄, LiPF₆, LiN(SO₂CF₃)₂, LiN(SO₂C₂F₅)₂, and LiPF₆₋ₓ(CₙF₂ₙ₊₁)x (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. Preferable examples of the solvent include carbonate-based solvents such as ethylene carbonate (EC), methyl ethyl carbonate (MEC), propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A battery module comprising:
a multi-cell assembly comprising a plurality of cells stacked to each other, each cell having a positive electrode terminal and a negative electrode terminal connected in series or in parallel respectively to a positive electrode terminal and a negative electrode terminal of an adjacent cell; and
heat absorbers each disposed in an internal space of each of connection portions of the positive and negative electrode terminals so as to be in contact with the connection portion,
wherein at least one of the heat absorbers located closer to a central portion of the multi-cell assembly with respect to the cell stacking direction has a greater volume than at least one of the heat absorbers located closer to a periphery of the multi-cell assembly.

2. The battery module according to claim 1, further comprising:
a radiation sheet disposed on a side face of the multi-cell assembly, wherein
the radiation sheet covers a current collector-side edge in a side face of the multi-cell assembly substantially entirely from one end to another end, and the radiation sheet has a tapered shape such as to gradually converge from the current collector-side edge to the opposite side edge toward a central portion of the multi-cell assembly with respect to a cell stacking direction.

3. The battery module according to claim 1, further comprising a heat absorbing sheet covering at least a current collector-side edge in a side face of the multi-cell assembly substantially entirely from one end to another end.

4. The battery module according to claim 2, further comprising a heat absorbing sheet covering at least a current collector-side edge in a side face of the multi-cell assembly substantially entirely from one end to another end.

5. A battery module comprising:
a multi-cell assembly comprising a plurality of cells stacked to each other, each cell having a positive electrode terminal and a negative electrode terminal connected in series or in parallel respectively to a positive electrode terminal and a negative electrode terminal of an adjacent cell; and
a heat absorber disposed in a surrounding space around each of connection portions of the positive and negative electrode terminals so as to be in contact with the connection portion,
wherein the heat absorber has a greater volume in a central portion thereof with respect to the cell stacking direction than in a periphery thereof.

6. The battery module according to claim 5, further comprising:
a radiation sheet disposed on a side face of the multi-cell assembly, wherein
the radiation sheet covers a current collector-side edge in a side face of the multi-cell assembly substantially entirely from one end to another end, and the radiation sheet has a tapered shape such as to gradually converge from the current collector-side edge to the opposite side edge toward a central portion of the multi-cell assembly with respect to a cell stacking direction.

7. The battery module according to claim 5, further comprising a heat absorbing sheet covering at least a current collector-side edge in a side face of the multi-cell assembly substantially entirely from one end to another end.

8. The battery module according to claim 6, further comprising a heat absorbing sheet covering at least a current collector-side edge in a side face of the multi-cell assembly substantially entirely from one end to another end.
